(19) United States
(12) Patent Application Publication
(10) Pub. No.: US 2023/0236721 A1
(43) Pub. Date: Jul. 27, 2023

(54) USER DEVICE FOR DISPLAYING A USER-INTERFACE OBJECT AND METHOD THEREOF

(71) Applicant: Telefonaktiebolaget LM Ericsson (publ), Stockholm (SE)

(72) Inventors: Peter Ökvist, LULEÅ (SE); Tommy Arngren, SÖDRA SUNDERBYN (SE); Andreas Kristensson, SÖDRA SANDBY (SE)

(21) Appl. No.: 18/011,927

(22) PCT Filed: Jul. 1, 2020
(86) PCT No.: PCT/EP2020/068545

§ 371 Date: Dec. 21, 2022

(51) Int. Cl. G06F 3/0488; G06F 3/041; G06F 3/14; G06F 3/0485

(52) U.S. Cl. CPC G06F 3/0488; G06F 3/0412; G06F 3/1431; G06F 3/1438; G06F 3/0485; G06F 3/0414

(57) ABSTRACT

Various embodiments disclosed herein are directed to a user device for displaying a user-interface object. The user device includes a first display device with a touch-sensitive interface, at least one processor, and at least one memory storing instructions executable by the processor. The instructions executable by the processor are configured to identify a defined touch gesture applied to the touch-sensitive interface. The instructions executable by the processor are also configured to display a user-interface, UI, object, which has been displayed on the first display device, on a second display device communicatively coupled to the user device responsive to the identification of the defined touch gesture.

### TECHNICAL FIELD

The present disclosure relates to a user device, a method performed by a user device, and a computer program product.

### BACKGROUND

Modern smartphones are becoming available that have “dual displays”, i.e., a first display device that during “normal operations” is facing the user and a second display device that is then facing away from the user. Because only one display device is viewable to a user at a time, it can be difficult for users to manage what information and where information is being displayed on the non-viewed display device. Users may feel the need to flip the smartphone back and forth to alternately view each display device, which can detract from the user's acceptance of the dual screen arrangement.

### SUMMARY

Various embodiments disclosed herein are directed to a user device for displaying one or more user-interface objects, e.g., application icons or application windows. The user device includes a first display device with a touch-sensitive interface, at least one processor, and at least one memory storing instructions executable by the processor. The instructions executable by the processor are configured to identify a defined touch gesture applied to the touch-sensitive interface. The instructions executable by the processor are also configured to display a user-interface (UI) object, which has been displayed on the first display device, on a second display device communicatively coupled to the user device responsive to the identification of the defined touch gesture.

Potential advantages of these operations can include making it more intuitive for a user to select a UI object that is to be moved or duplicated from the first display device to being displayed on the second display device. Moreover, the operations may enable the user to position where the UI object is then being displayed on the second display device. These operations may be particularly helpful for a user operating a user device having display devices located on opposite sides, where the user can essentially view only one of the display devices at a time. These operations may enable one user who is viewing a UI object on the first display device to cause the UI object to become displayed on the second display device for viewing by another user.

Some other related embodiments are directed to a method performed by a user device including a first display device with a touch-sensitive interface. The method includes identifying a defined touch gesture applied to the touch-sensitive interface. The method further includes displaying a UI object, which has been displayed on the first display device, on a second display device communicatively coupled to the user device responsive to the identification of the defined touch gesture.

Some other related embodiments are directed to a computer program product including a non-transitory computer readable medium storing instructions that are executable by a processor of a user device to perform the method of embodiments discussed herein.

Other related systems, methods, and computer program products according to embodiments will be or become apparent to one with skill in the art upon review of the following drawings and detailed description. It is intended that all such additional systems, methods, and computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates a user device for displaying a user-interface object in accordance with some embodiments;

FIG. 2 illustrates a flowchart of operations performed by the user device of FIG. 1 in accordance with some embodiments;

FIG. 3 illustrates a UI object from the second display device being overlaid over a UI object from the first display device in accordance with some embodiments;

FIG. 4 illustrates a flowchart of operations performed by the user device of FIG. 3 in accordance with some embodiments;

FIG. 5 illustrates an application icon on the first display device being moved or duplicated on the second display device in accordance with some embodiments;

FIG. 6 illustrates a flowchart of operations performed by the user device of FIG. 5 in accordance with some embodiments

FIG. 7 illustrates a flowchart of other operations performed by the user device of FIG. 5 in accordance with some embodiments;

FIG. 8 illustrates an application icon on the first display device being positioned at a location on the second display device based on an aim-point defined in accordance with some embodiments; and

FIG. 9 is a block diagram of components of a user device that are configured in accordance with some other embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

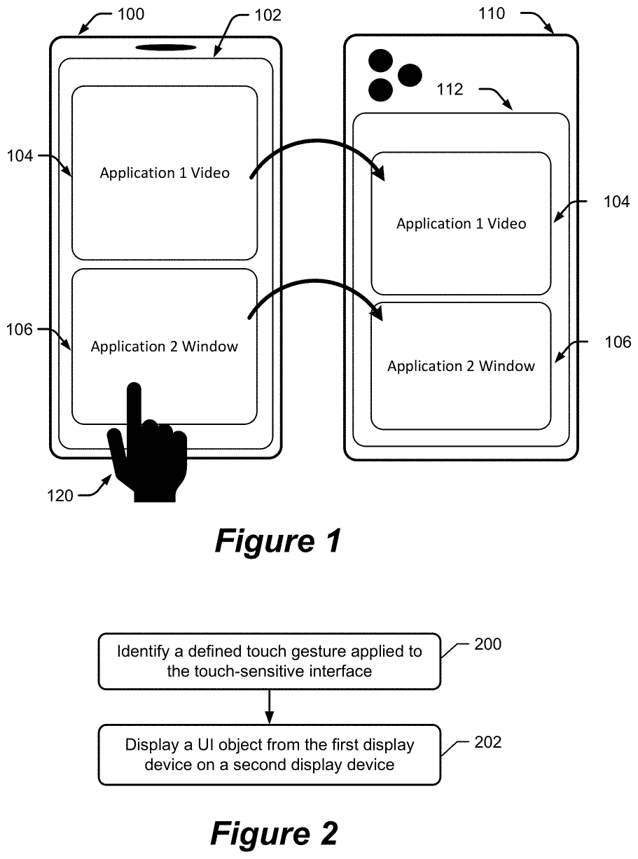

FIG. 1 illustrates a user device for displaying a user-interface object in accordance with some embodiments. FIG. 2 illustrates a flowchart of operations performed by the user device of FIG. 1 in accordance with some embodiments. Referring to FIGS. 1 and 2, a user device includes a first display device 100 with a touch-sensitive interface 950, at least one processor 930, and at least one memory 910 storing instructions 920 executable by the processor 930 to perform operations and associated methods. The operations identify 200 a defined touch gesture 120 applied to the touch-sensitive interface. Responsive to the identification of the defined touch gesture 120, the operations display a user-interface (UI) object 104 and 106, which has been displayed on the first display device 100, on a second display device 110 that is communicatively coupled to the user device 900.

The UI object 104 and 106 may be icons that are user selectable to trigger execution of associated applications, windows that are displaying an image or a video from a web-browser or media player application, windows that are displaying information from user applications (e.g., game application, messaging application, email application, camera, etc.), etc.

Potential advantages of these operations can include making it more intuitive for a user to select a UI object that is to be moved or duplicated from the first display device to being displayed on the second display device. Moreover, the operations may enable the user to position where the UI object is then being displayed on the second display device. These operations may be particularly helpful for a user operating a user device having display devices located on opposite sides, where the user can essentially view only one of the display devices at a time. These operations may enable one user who is viewing a UI object (e.g., an application icon, video window, etc.) on the first display device to cause the UI object to become displayed on the second display device for viewing by another user.

A further example implementation of these operations is illustrated in FIG. 1. Prior to the UI object 104 and 106 being displayed on the second display device 110, the first display device 100 displays a screen of a plurality of the UI objects 104, 106. Responsive to the identification of the defined touch gesture 120 applied to the touch-sensitive interface 950, the screen of a plurality of the UI objects 104 and 106 is moved or duplicated from the first display device 100 to the second display device 110 for display.

In some embodiments, the second display device 110 is collocated on the user device with the first display device 100. In the example of FIG. 1, the first display device 100 can be integrated into a first face of the user device 900 and the second display device 110 can be integrated into a second face of the user device 900, which may be opposite to the first face.

In some other embodiments, the second display device 110 is located on a separate device, such as another smartphone, tablet computer, computer display, laptop, television, etc. In the example of FIG. 1, the first display device 100 can be integrated into a first face of the user device 900 and the second display device 110 can be integrated into a face of another user device communicatively coupled to the at least one processor 930 of the user device 900.

For example, the user device displays the UI object in a transverse location on the second display device. Determining transverse locations between two opposite facing displays, or in general determining dual locations for an application icon transferred from one display to another display, may be an early step in the exemplified action of moving (herein also referred to as “pushing”) an application icon (or other UI object) from a source position on a first display device to a target location displayed by a second display device of the same or other user device.

Various further embodiments will now be described in the context of moving or duplicating an application icon, although these embodiments may more generally be used with any form of UI object.

In a further example with a user device having a symmetrically folded display (e.g., of PixelSize pxtot;pytot) and wrapped over one edge/side of the user device, an application icon or other UI object residing at location (px;py) on the first display (of the first display device) can be copied or moved for display on the second display by operations that determine a display location (pxtot-px;py) on the second display (of the second display device), e.g., assuming an ideal display in terms of no-curvature folding-edge and/or display-hinge artifacts.

In the another example, the determination of where to copy or move an application icon from the first display device to be displayed on the second display device may be based on consideration of a row and column location of the application icon on the first display device mapped to a row and column location for displaying the application icon on the second display device.

In a scenario where the first and second display devices are different dimensional sizes, the determination of where an application icon or other UI object which is displayed on the first display devices is to be moved to or duplicated on the second display device can be include scaling, interpolating, and/or extrapolating (e.g., linear, logarithmic or according to some bound function) the location of the application icon on the first display device to determine the corresponding location for displaying the application icon on the second display device.

In another scenario where the first and second display devices have different display resolutions, the scaling, interpolating, and/or extrapolating operations may be similarly performed to determine where an application icon, which has been displayed on the first display device, is to be displayed on the second display device based on comparison of the display resolutions.

In some further embodiments, user device settings may be used to determine where the application icon or other UI object will be displayed on the second display device and/or a priority at which the application icon will be displayed on the second display device relative to other displayed application icons. For example, if the second display is totally empty at the targeted pixel positions (and sufficient pixel space is available surrounding, corresponding to one icon grid position, or similar), the application icon will be displayed on the second display device without any further considerations of display size differences, resolution differences, and/or effect on other application icons.

On the other hand, if the targeted position at the second display already is occupied by some icon, application, or other UI object, the system may further determine which UI object has highest precedence or priority for display, and with that information evaluate which of the UI objects should be displayed at the targeted position. A further determination can be made as to how the lower-priority UI object will be organized for display, such as within a lower hierarchical folder.

How the application icon or other UI object is to be displayed on the second display device can be based determination of prioritization of the application icon relative to other application icons being displayed on the second display device. Icon position priorities may be defined based on various defined types of application, e.g. an OS-native application such as “Settings” or “Call” or “Mail” can be defined to have a higher high priority than other types of applications, e.g. game applications and other applications downloaded by a user from an application store.

Icon position priorities determine where among a plurality of different display layers the application displayed on the second display device; e.g. one priority given for entering base desktop/display, and another other priority if targeting a virtual display layers such as “widget.”

In some embodiments, the operations can swap UI objects between the first and second display devices, such as between front and back displays of the user device. For example, the current front display can be swapped to become the back display (and vice versa) responsive to identifying the defined touch gesture.

In another embodiment, prior to the UI object being displayed on the second display device 110, the first display device 100 displays a first screen 102 of a first plurality of the UI objects and the second display device 110 displays a second screen 112 of a second plurality of the UI objects. Responsive to the identification of the defined touch gesture 120 applied to the touch-sensitive interface, a display swap operation is performed wherein the first screen 102 of the first plurality of the UI objects is moved from the first display device 100 to the second display device 110 for display and the second screen 112 of the second plurality of the UI objects is moved from the second display device 110 to the first display device 100 for display.

In a further embodiment, the display swap operation is reversed responsive to no longer identifying the touch-sensitive interface is no longer being touched, which may correspond to the user non longer touching the first display device. In other words, the first screen 102 of the first plurality of the UI objects is again displayed on the first display device 100 and the second screen 112 of the second plurality of the UI objects is again displayed on the second display device 110.

One example operational use scenario for display swapping is related to a user who intends to move (e.g., one finger) or duplicate (e.g., two fingers) an application icon from the front display device to the back display device. As the user touches the front display device in a defined manner (e.g., applying threshold pressure indicating 3D gesture) will trigger the user device to swap what is displayed on the front and back display devices so the user can view the application icon arranged among UI objects formerly displayed on the back display device while viewing them now displayed on the front display device. The user may define a location for where the application icon is to be displayed based on a gesture (e.g., which may be with the same threshold pressure or another threshold pressure e.g., less pressure) while dragging the application icon to that location. When the user ceases touching the front display device in the defined manner, e.g., by releasing the dragged application icon at its desired target position, the user device can responsively swap back what is displayed on the front and back display devices.

Another example operational implementation of display swapping is related to a user who wants to temporarily display content, such as on the back display or on both displays, simultaneously, for instance, for sharing an image or video, or an application window, with another user viewing the back display. This example may include the following steps. The user may select one or more UI objects on the front facing display. The user activates 3D touch to display the selected UI object(s) on the back display or on both displays. One finger gesture may correspond to a command to display the selected UI object(s) only on the back display, and a two finger gesture may correspond to a command to display the selected UI object(s) simultaneously on both the front and back displays, or vice versa.

In some embodiments, the user may apply a threshold touch pressure to the touch sensitive interface of the back display to cause UI objects displayed thereon to be displayed as an overlay on UI objects being displayed on the front display, or vice versa. As the UI objects are copied or moved from the front display to the back display, or vice versa, the user may perceive the overlaid combination of UI objects as providing a 3D visualization experience of both displays. The user device may provide the user a notification when the user device determines that UI objects have reached the back display, such as by sound, vibration, visualization, or combinations thereof. UI objects may temporarily be displayed on back display for a certain time duration (e.g., defined by a timer value), or as long as the finger is touching the front and/or back display.

Another example for display swapping may be operations that enable the user who draws a free form curve of the front facing display to have that free form curve displayed on the back display or have the free form curve displayed magnification (e.g., zoomed-in) on the back display.

In another embodiment, responsive to the UI object being moved by the user to a target location on the second display device (110), the UI object is ceased being displayed on the first display device (100).

The embodiments discussed herein may make use of any of a plurality of different defined touches, also referred to as touch gestures 120. For example, a touch gesture could be any defined type of touch on a touch-sensitive interface, such as, a long hard tap, three-dimensional (3D) touch (e.g., varying threshold levels of pressure applied by the user to the touch sensitive interface), or any other touch gesture. For example, a first threshold level of touch pressure applied to an application icon displayed on the first display device may cause that application icon to become displayed on the second display device, and a change in applied touch pressure to a second level (e.g., lighter continuing touch) may cause the application icon to be moved on the second display device to tracking movement of where the touch pressure is being applied to the first display device.

The user device may be configured to operationally distinguish between short-taps and longer-taps and tap-hold action performed on the touch sensitive interface. For example, the user device may identify a “hard tapping/pressing” of a finger on the touch sensitive interface, e.g., either in terms of true force sensing or in terms of emulated load sensing. The display device may detect a “small-contact-area, short duration” finger-display contact differently than an “ordinary tap” or a “large-contact-area, long duration” touch.

The display device may associate detection of a “hard long tap” gesture as triggering a defined operation for how a UI object is to be displayed, such as to triggering movement of the UI object from the first display device to the second display device and/or controlling whether the UI object is displayed a root level of a hierarchy of display layers or is displayed at a lower display level, e.g., within a folder.

With further reference to FIG. 1, in one embodiment the defined touch gesture 120 corresponds to a first threshold level of press against the touch-sensitive interface. Additionally, responsive to identifying a second threshold level of press applied to the touch-sensitive interface, the operations move the UI object to track sliding movements of touch locations on the touch-sensitive interface.

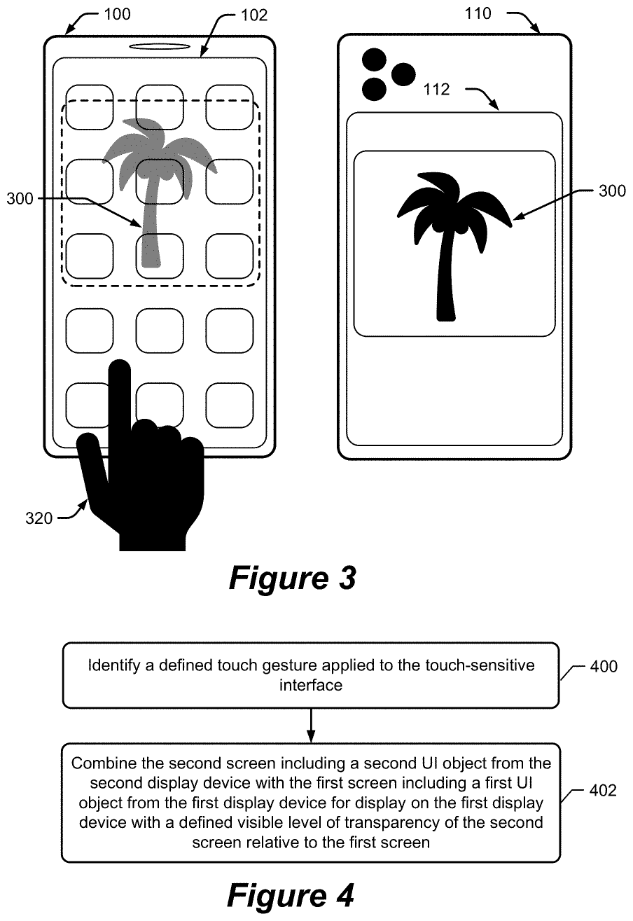

FIG. 3 illustrates a UI object from the second display device being overlaid over the UI object from the first display device in accordance with some embodiments.

FIG. 4 illustrates a flowchart of operations performed by the user device of FIG. 3 in accordance with some embodiments.

Referring to FIGS. 2, 3 and 4, in some embodiments, prior to the UI object being moved or duplicated from the first display device 100 to the second display device 110, the first display device 100 displays a first screen 102 including the UI object and the second display device 110 displays a second screen 112 including second UI object 300. Additionally, responsive to the identification 200 and 400 of the defined touch gesture 320 applied to the touch-sensitive interface, the second screen 112 including the second UI object 300 is displayed in combination 402 with the first screen 102 including the UI object on the first display device 100 with a defined visible level of transparency of the second screen 112 relative to the first screen 102.

The defined visible level of transparency of the second screen 112 relative to the first screen 102 can be controlled responsive to a determined level of press against the touch-sensitive interface while the defined touch gesture 320 is being applied to the touch-sensitive interface.

For example, a defined touch gesture, such as a hard long tap or three dimensional touch, a front display device can operate to trigger a see-through function that enables a user to “see through the device” to view what is displayed on the back display device without the user needing to physically flip the user device to view the backside.

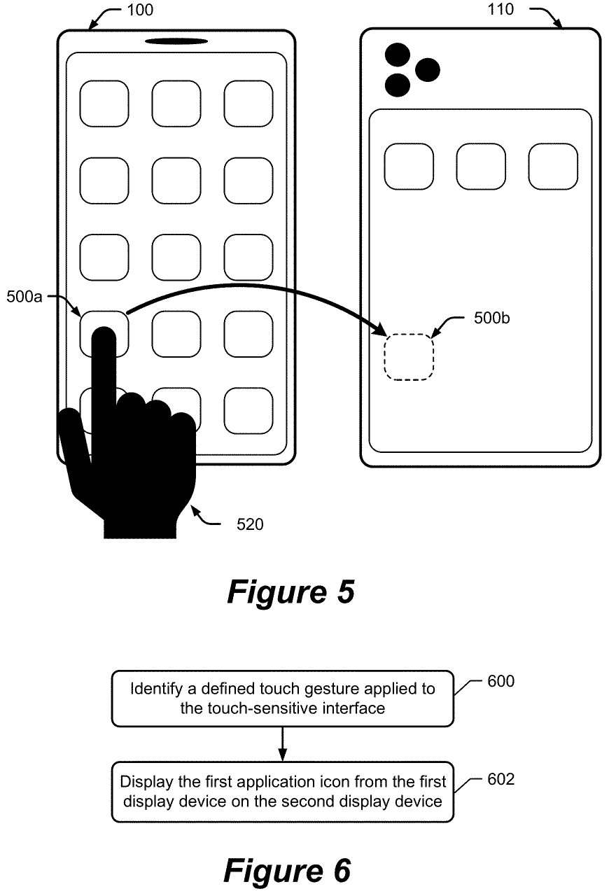

FIG. 5 illustrates an application icon on the first display device being moved or duplicated on the second display device in accordance with some embodiments.

FIG. 6 illustrates a flowchart of operations performed by the user device of FIG. 5 in accordance with some embodiments.

As used herein, the terms “duplicate” and “duplicating” of a UI object displayed on a first display device onto a second display device can include creating an identical UI object or another representation of the UI object on the second display device. In the case of a application icon which is touch selectable to trigger execution of an associated application program, the duplicated application icon may be different but still programmatically associated with the application program to enable touch-based execution thereof. Accordingly, execution of the application program can be controlled from display devices.

Referring to FIGS. 2, 5 and 6, in some embodiments the at least one memory 910 stores applications each associated with an application icon 500 that is touch selectable to trigger execution of the application by the processor 930. The UI object includes a first application icon 500 programmatically linked with a first application. Additionally, prior to the UI object being displayed 202 on the second display device 110, the first display device 100 displays the first application icon 500. Additionally, responsive to identifying 200 and 600 the defined touch gesture 520 applied to the touch-sensitive interface, the operations display 202 and 602 the first application icon 500 from the first display device 100 on the second display device 110. When the operation is moving the UI object from the first display device 100 to the second display device 110, the operation to display 202 and 602 the first application icon 500 includes displaying the first application icon 500 on the second display device 110 and ceasing display of the first application icon 500 on the first display device 100. The programmatic association between the UI object and the application can then be updated to refer to the UI object now located on the second display device 110.

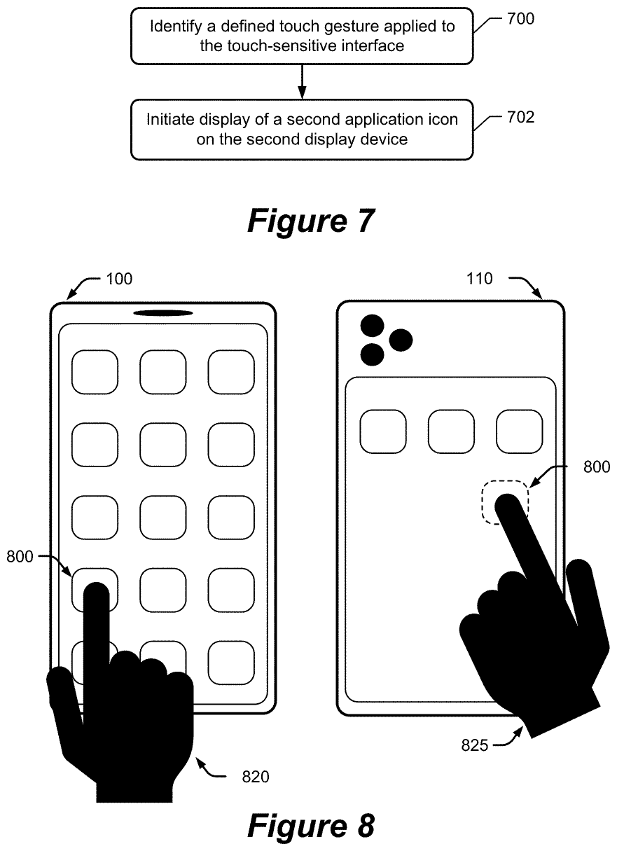

FIG. 7 illustrates a flowchart of other operations performed by the user device of FIG. 5 in accordance with some embodiments. These operations can correspond to duplicating an application icon from the first display device 100 onto the second display device 110.

Referring to FIGS. 2, 5, and 7, in some embodiments the at least one memory 910 stores applications each associated with an application icon 500a that is touch selectable to trigger execution of the application by the processor 930. The UI object includes a first application icon 500a programmatically linked to control execution of a first application. Additionally, prior to the UI object being displayed 202 on the second display device 110, the first display device 100 displays the first application icon 500a. Responsive to identifying 200 and 700 the defined touch gesture 520 applied to the touch-sensitive interface, the operations initiate 702 display of a second application icon 500b on the second display device 110 that controls execution of the first application. A further programmatic association is then created between the second application icon 500b and the application to refer to the second application icon 500b now located on the second display device 110.

FIG. 8 illustrates an application icon on the first display device being positioned at a location on the second display device based on an aim-point defined in accordance with some embodiments.

In some embodiments, an aim-point is used to guide the location of application icon displayed on a second display device. Referring to FIG. 8, in some of the embodiments the stored instructions 920 executable by the processor 930 are further configured to identify an aim-point on the second display device 110 based on a touch 825 performed on the second display device 110. The first application icon 800 is positioned on the second display device 110 based on the aim-point.

For example, a user may use a finger positioned at the backside of the user device, for example touching the back display of the user device, to indicate on the backside display (e.g., second display device 110) where an icon or other UI object is to be copied or moved from the frontside of the user device (e.g., from the first display device 100). In other words, the finger serves as an aiming-point for where the icon will appear on the backside display.

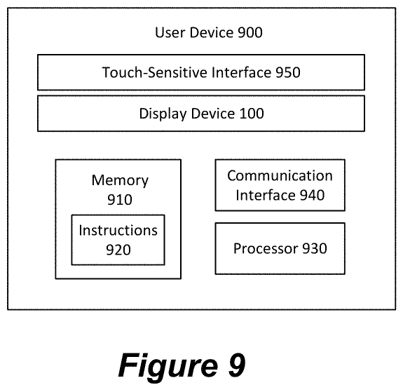

FIG. 9 is a block diagram of components of a user device 900 that are configured in accordance with some other embodiments of the present disclosure. The user device 900 can include at least one processor circuit 930 (processor) and at least one memory circuit 910 (memory) which is also described below as a computer readable medium. The memory 910 stores instructions 920 that are executed by the processor 930 to perform operations disclosed herein for at least one embodiment of the user device 900. The processor 930 may include one or more data processing circuits, such as a general purpose and/or special purpose processor (e.g., microprocessor and/or digital signal processor), which may be collocated or distributed across one or more data networks. The user device 900 may further include a display device 100, a touch-sensitive interface 950, and a communication interface 940.

In some embodiments, a computer program product including a non-transitory computer readable medium storing instructions that are executable by a processor of a user device to perform the method performed by the user device as discussed in various embodiments above.

One use case can include app icon re-location from a device's first display to second (transverse) display.

Another use case can include general two-user two-sided operations where a second user may be provided a request for password/authentication to the first user which is not observable on the backside of the device and, therefore reduces or avoids possibility for password sneak-peeking. The first user may copy or move application authentication interface information to the backside using a defined touch gesture.

Another use case can include two-person content sharing, such as displaying a video clip or image on both front and back-facing display device or only on back-facing display device.

Another use case can include two-person co-creation, such as making both displays available for user interfacing to a same application.

Another use case can include two-person two-sided-device gaming, such as battleship, four in a row, tic-tac-toe, or alike.

Further definitions and embodiments are explained below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, circuits or functions but does not preclude the presence or addition of one or more other features, integers, elements, steps, circuits, functions or groups thereof. Furthermore, as used herein, the common abbreviation “e.g.”, which derives from the Latin phrase “exempli gratia,” may be used to introduce or specify a general example or examples of a previously mentioned item and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits, implemented by analog circuits, and/or implement by hybrid digital and analog circuits. Computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. user device comprising:
a first display device with a touch-sensitive interface;
at least one processor; and
at least one memory storing instructions executable by the processor to:
identify a defined touch gesture applied to the touch-sensitive interface; and
responsive to the identification of the defined touch gesture, display a user-interface, UI, object, which has been displayed on the first display device, on a second display device communicatively coupled to the user device.

2. The user device of claim 1, wherein:
the first display device is integrated into a first face of the user device and the second display device is integrated into a second face of the user device.

3. The user device of claim 1, wherein:
the first display device is integrated into a first face of the user device and the second display device is integrated into another user device communicatively coupled to the at least one processor of the user device.

4. The user device of claim 1, wherein:
prior to the UI object being displayed on the second display device, the first display device displays a screen of a plurality of UI objects; and
responsive to the identification of the defined touch gesture applied to the touch-sensitive interface, the screen of the plurality of the UI objects is displayed on the second display device.

5. The user device of claim 1, wherein:
prior to the UI object being displayed on the second display device, the first display device displays a first screen of a first plurality of the UI objects and the second display device displays a second screen of a second plurality of the UI objects; and
responsive to the identification of the defined touch gesture applied to the touch-sensitive interface, the first screen of the first plurality of the UI objects is moved from the first display device to the second display device for display and the second screen of the second plurality of the UI objects is moved from the second display device to the first display device for display.

6. The user device of claim 5, wherein:
the defined touch gesture corresponds to a first threshold level of press against the touch-sensitive interface;
responsive to identifying a second threshold level of press applied to the touch-sensitive interface, moving the UI object on the second display device to track sliding movements of touch locations on the touch-sensitive interface.

7. The user device of claim 1, wherein:
responsive to the UI object being moved by the user to a target location on the second display device, cease displaying the UI object on the first display device.

8. The user device of claim 1, wherein:
prior to the UI object being displayed on the second display device, the first display device displays a first screen including the UI object and the second display device displays a second screen including a second UI object;
responsive to the identification of the defined touch gesture applied to the touch-sensitive interface, the second screen including the second UI object from the second display device is combined with the first screen including the UI object from the first display device for display on the first display device with a defined visible level of transparency of the second screen relative to the first screen.

9. The user device of claim 8, wherein:
the defined visible level of transparency of the second screen relative to the first screen is controlled responsive to a determined level of press against the touch-sensitive interface while the defined touch gesture is being applied to the touch-sensitive interface.

10. The user device of claim 1, wherein:
the at least one memory stores applications each associated with an application icon that is touch selectable to trigger execution of the application by the processor, wherein the UI object includes a first application icon programmatically linked with a first application;
prior to the UI object being displayed on the second display device, the first display device displays the first application icon; and
responsive to identifying the defined touch gesture applied to the touch-sensitive interface, the first application icon is displayed on the second display device and ceasing display of the first application icon on the first display device.

11. The user device of claim 1, wherein:
the at least one memory stores applications each associated with an application icon that is touch selectable to trigger execution of the application by the processor, wherein the UI object includes a first application icon programmatically linked to control execution of a first application;
prior to the UI object being displayed on the second display device, the first display device displays the first application icon; and
responsive to identifying the defined touch gesture applied to the touch-sensitive interface, initiate display of a second application icon on the second display device that controls execution of the first application.

12. The user device of claim 10, further comprising:
identify an aim-point on the second display device based on a touch performed on the second display device,
wherein the first application icon is positioned on the second display device based on the aim-point.

13. A method performed by a user device including a first display device with a touch-sensitive interface, the method comprising:
identifying a defined touch gesture applied to the touch-sensitive interface; and
responsive to the identification of the defined touch gesture, displaying a user-interface, UI, object, which has been displayed on the first display device, on a second display device communicatively coupled to the user device.

14. The method of claim 13, wherein:
the first display device is integrated into a first face of the user device and the second display device is integrated into a second face of the user device.

15. The method of claim 13, wherein:
the first display device is integrated into a first face of the user device and the second display device is integrated into another user device communicatively coupled to the user device.

16. The method of claim 13, wherein:
prior to the UI object being displayed on the second display device, the first display device displays a screen of the plurality of UI objects; and
responsive to identifying the defined touch gesture applied to the touch-sensitive interface, the screen of the plurality of the UI objects is displayed on the second display device.

17. The method claim 13, wherein:
prior to the UI object being displayed on the second display device, the first display device displays a first screen of a first plurality of the UI objects and the second display device displays a second screen of a second plurality of the UI objects; and
responsive to identifying the defined touch gesture applied to the touch-sensitive interface, the first screen of the first plurality of the UI objects is moved from the first display device to the second display device for display and the second screen of the second plurality of the UI objects is moved from the second display device to the first display device for display.

18. The method of claim 17, wherein:
the defined touch gesture corresponds to a first threshold level of press against the touch-sensitive interface;
responsive to identifying a second threshold level of press applied to the touch-sensitive interface, moving the UI object on the second display device to track sliding movements of touch locations on the touch-sensitive interface.

19. The method of claim 13, wherein:
responsive to the UI object being moved by the user to a target location on the second display device, ceasing display of the UI object on the first display device.

20. The method of claim 13, wherein:
prior to the UI object being displayed on the second display device, the first display device displays a first screen including the UI object and the second display device displays a second screen including a second UI object;
responsive to identifying the defined touch gesture applied to the touch-sensitive interface, the second screen including the second UI object from the second display device is combined with the first screen including the UI object from the first display device for display on the first display device with a defined visible level of transparency of the second screen relative to the first screen.

21. The method of claim 20, wherein:
the defined visible level of transparency of the second screen relative to the first screen is controlled responsive to a determined level of press against the touch-sensitive interface while the defined touch gesture is being applied to the touch-sensitive interface.

22. The method of claim 13, wherein:
at least one memory of the user device stores applications each associated with an application icon that is touch selectable to trigger execution of the application by at least one processor of the user device, wherein the UI object includes a first application icon programmatically linked with a first application;
prior to the UI object being displayed on the second display device, the first display device displays the first application icon; and
responsive to identifying the defined touch gesture applied to the touch-sensitive interface, displaying the first application icon on the second display device and ceasing display of the first application icon on the first display device.

23. The method of claim 13, wherein:
at least one memory of the user device stores applications each associated with an application icon that is touch selectable to trigger execution of the application by at least one processor of the user device, wherein the UI object includes a first application icon programmatically linked to control execution of a first application;
prior to the UI object being displayed on the second display device, the first display device displays the first application icon; and
responsive to identifying the defined touch gesture applied to the touch-sensitive interface, initiating display of a second application icon on the second display device that controls execution of the first application.

24. The method claim 22, further comprising:
identifying an aim-point on the second display device based on a second touch gesture performed on the second display device,
wherein the first application icon is positioned on the second display device based on the aim-point.

25. A computer program product comprising a non-transitory computer readable medium storing instructions that are executable by a processor of a user device to perform the method of claim 13.
